(19) United States
(12) Patent Application Publication
(10) Pub. No.: US 2026/0207009 A1
(43) Pub. Date: Jul. 23, 2026

(54) Lid Assembly, Blender System, and Method for Restricting a Processing Volume

(71) Applicant: SharkNinja Operating LLC, Needham, MA (US)

(72) Inventors: Pierce James Barnard, Needham, MA (US); Aishazhan Abuova, Needham, MA (US); Yu Ri Kim, Needham, MA (US)

(21) Appl. No.: 19/032,179

(22) Filed: Jan. 20, 2025

(51) Int. Cl. A47J 43/07; A47J 43/046; B01F 27/808; B01F 35/45; B01F 101/00

(52) U.S. Cl. CPC A47J 43/0722; A47J 43/046; B01F 27/808; B01F 35/45; B01F 2101/1805

(57) ABSTRACT

A blender, a lid assembly for a blender system, and methods for restricting a processing volume are disclosed. The lid assembly includes a cover configured to engage an open end of a container, a telescoping piston shaft connected to the cover and configured to telescopically extend toward a bottom of the container and telescopically retract away from the bottom of the container, and a piston head connected to a lower end of the telescoping piston shaft. The piston head includes a flexible seal along a perimetric edge of the piston head configured to engage with at least one wall of the container when the telescoping piston shaft is at least partially extended, the piston head configured to restrict a processing volume of the container to a volume bounded by a lower surface of the piston head, the at least one wall of the container, and the bottom of the container.

### BACKGROUND

### Technical Field

This disclosure relates generally to blender systems and, in some non-limiting embodiments or aspects, to lid assemblies, blender systems, and methods for restricting a processing volume of a blender container.

### Technical Considerations

The performance of blender systems (e.g., blenders, food processors, blade grinders, and the like) is partly related to the proximity of the contents being processed to the blending apparatus (e.g., a blade assembly). Blender system performance is improved by the contents maintaining close proximity to and contact with the blending apparatus.

However, blender system performance is reduced when the contents being processed fail to timely return to the blending apparatus after being propelled away from the blending apparatus, or when the contents fail to return at all, for example, due to the formation of air pockets (e.g., bubbles and/or the like), adhesion of the contents to the blender container, and/or cohesion among the contents. For example, scattering may occur where the contents being processed have an overly long circulation path in the blender container. Additionally, or alternatively, cavitation may occur when the contents form a cavity (e.g., air pocket, bubble, and/or the like) around the blending apparatus. Scattering and/or cavitation may cause a blender system to inefficiently blend the contents and/or may interrupt the blending process entirely.

There is a need for a technical solution to restrict a processing volume of a blender container, to reduce scattering of processed contents, decrease a circulation distance of processed contents, and prevent cavitation of the contents around the blending apparatus.

### SUMMARY

Accordingly, provided are lid assemblies, blender systems, and methods for restricting a processing volume of a blender container (e.g., that overcome some or all of the deficiencies identified above).

According to some non-limiting embodiments or aspects, provided are lid assemblies for use in a blender system. A lid assembly for use in a blender system may include a lid cover configured to engage an open end of a container of the blender system, a telescoping piston shaft connected to the lid cover and configured to telescopically extend toward a bottom of the container and telescopically retract away from the bottom of the container, and a piston head connected to a lower end of the telescoping piston shaft. The piston head may include a flexible seal along a perimetric edge of the piston head configured to engage with at least one wall of the container when the telescoping piston shaft is at least partially extended, the piston head may be configured to restrict a processing volume of the container to a volume bounded by a lower surface of the piston head, the at least one wall of the container, and the bottom of the container.

In certain configurations, the telescoping piston shaft includes at least two piston shaft segments, and wherein a first piston shaft segment of the at least two piston shaft segments is at least partially positioned inside a second piston shaft segment of the at least two piston shaft segments. The at least two piston shaft segments may further include a third piston shaft segment, and wherein the second piston shaft segment is at least partially positioned inside the third piston shaft segment. The first piston shaft segment and the second piston shaft segment may each include an external threading, wherein the third piston shaft segment comprises internal threading configured to engage with the external threading of the second piston shaft segment, wherein the telescoping piston shaft is configured to telescopically extend when a first rotational force is applied in a first rotational direction to the first piston shaft segment, and wherein the telescoping piston shaft is configured to telescopically retract when a second rotational force is applied in a second rotational direction opposite the first rotational direction to the first piston shaft segment.

In certain configurations, the lid assembly may further include a shroud at least partially encasing the second piston shaft segment and configured to slidably engage along an outer surface of the third piston shaft segment, the shroud comprising internal threading configured to engage with the external threading of the first piston shaft segment. The lid assembly may also further include a cavity in the lid cover configured to at least partially house the telescoping piston shaft, and a shroud at least partially encasing the telescoping piston shaft and configured to slidably engage along an outer surface of the telescoping piston shaft. The shroud may have a diameter configured to block contents in the container from entering the cavity during operation of the blender system.

In other configurations, the lid assembly may also include a gear assembly connected to the lid cover and mechanically engaged with an upper end of the telescoping piston shaft, and a motor having a drive shaft connected to the gear assembly, the motor configured to cause, via the gear assembly, the telescoping piston shaft to telescopically extend when the drive shaft is rotated in a first driving direction, and the motor configured to cause, via the gear assembly, the telescoping piston shaft to telescopically retract when the drive shaft is rotated in a second driving direction opposite the first driving direction. The lid assembly may further include a rotatable handle connected to the lid cover and mechanically engaged with an upper end of the telescoping piston shaft, the rotatable handle configured to cause the telescoping piston shaft to telescopically extend when the rotatable handle is rotated in a first rotational direction, and the rotatable handle configured to cause the telescoping piston shaft to telescopically retract when the rotatable handle is rotated in a second rotational direction opposite the first rotational direction.

In still other configurations, the flexible seal of the piston head is configured to restrict fluid transfer across the perimetric edge of the piston head when the flexible seal is engaged with the at least one wall of the container, and wherein the piston head further comprises at least one valve configured to permit gaseous fluid transfer from a lower surface of the piston head through an upper surface of the piston head when the telescoping piston shaft is telescopically extended while the flexible seal of the piston head is engaged with the at least one wall of the container.

In accordance with an embodiment of the present invention, a blender system includes a base, a container configured to be removably attached to the base, the container further configured to contain contents to be processed during operation of the blender system, a rotatable blade assembly positioned at least partly in the container, and a lid assembly. The lid assembly including a lid cover configured to engage an open end of the container, a telescoping piston shaft connected to the lid cover and configured to telescopically extend toward a bottom of the container and telescopically retract away from the bottom of the container, and a piston head connected to a lower end of the telescoping piston shaft. The piston head may include a flexible seal along a perimetric edge of the piston head and configured to engage with at least one wall of the container when the telescoping piston shaft is at least partially extended, the piston head configured to restrict a processing volume of the container to a volume bounded by a lower surface of the piston head, the at least one wall of the container, and the bottom of the container.

In certain configurations, the telescoping piston shaft includes at least two piston shaft segments, and wherein a first piston shaft segment of the at least two piston shaft segments is at least partially positioned inside a second piston shaft segment of the at least two piston shaft segments. In other configurations, the at least two piston shaft segments further includes a third piston shaft segment, and wherein the second piston shaft segment is at least partially positioned inside the third piston shaft segment. The first piston shaft segment and the second piston shaft segment may each comprise external threading, wherein the third piston shaft segment comprises internal threading configured to engage with the external threading of the second piston shaft segment, wherein the telescoping piston shaft is configured to telescopically extend when a first rotational force is applied in a first rotational direction to the first piston shaft segment, and wherein the telescoping piston shaft is configured to telescopically retract when a second rotational force is applied in a second rotational direction opposite the first rotational direction to the first piston shaft segment.

In certain configurations, the lid assembly may further include a shroud at least partially encasing the second piston shaft segment and configured to slidably engage along an outer surface of the third piston shaft segment, the shroud including an internal threading configured to engage with the external threading of the first piston shaft segment. In other configurations, the lid assembly further includes a cavity in the lid cover configured to at least partially house the telescoping piston shaft, and a shroud at least partially encasing the telescoping piston shaft and configured to slidably engage along an outer surface of the telescoping piston shaft, the shroud having a diameter configured to block contents in the container from entering the cavity during operation of the blender system.

In certain configurations, the lid assembly further includes a gear assembly connected to the lid cover and mechanically engaged with an upper end of the telescoping piston shaft, and a motor comprising a drive shaft connected to the gear assembly, the motor configured to cause, via the gear assembly, the telescoping piston shaft to telescopically extend when the drive shaft is rotated in a first driving direction, and the motor configured to cause, via the gear assembly, the telescoping piston shaft to telescopically retract when the drive shaft is rotated in a second driving direction opposite the first driving direction.

In certain configurations, the lid assembly further includes a rotatable handle connected to the lid cover and mechanically engaged with an upper end of the telescoping piston shaft, the rotatable handle configured to cause the telescoping piston shaft to telescopically extend when the rotatable handle is rotated in a first rotational direction, and the rotatable handle configured to cause the telescoping piston shaft to telescopically retract when the rotatable handle is rotated in a second rotational direction opposite the first rotational direction. The flexible seal of the piston head may be configured to restrict fluid transfer across the perimetric edge of the piston head when the flexible seal is engaged with the at least one wall of the container. The piston head may further include at least one valve configured to permit gaseous fluid transfer from a lower surface of the piston head through an upper surface of the piston head when the telescoping piston shaft is telescopically extended while the flexible seal of the piston head is engaged with the at least one wall of the container.

In accordance with an embodiment of the present invention, a method of operating a blender system having a lid assembly includes the steps of applying a first rotational force in a first rotational direction to an upper end of a telescoping piston shaft connected to a lid cover of the lid assembly, the first rotational force configured to cause the telescoping piston shaft to telescopically extend toward a bottom of a container of the blender system, activating a rotatable blade assembly of the blender system to process contents within a volume of the container, the volume bounded by a lower surface of a piston head comprising a flexible seal along a perimetric edge thereof and connected to a lower end of the telescoping piston shaft, at least one wall of the container engaged with the piston head, and the bottom of the container, and applying a second rotational force in a second rotational direction opposite the first rotational direction to the upper end of the telescoping piston shaft, the second rotational force configured to cause the telescoping piston shaft to telescopically retract away from the bottom of the container.

In certain configurations, the method step of applying the first rotational force includes activating a motor of the lid assembly to cause the motor to rotate a drive shaft in a first driving direction that causes a gear assembly connected to the drive shaft to apply the first rotational force in the first rotational direction to the upper end of the telescoping piston shaft. The method step of applying the second rotational force includes activating the motor of the lid assembly to cause the motor to rotate the drive shaft in a second driving direction opposite the first driving direction that causes the gear assembly connected to the drive shaft to apply the second rotational force in the second rotational direction to the upper end of the telescoping piston shaft.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details of the disclosure are explained in greater detail below with reference to the non-limiting, exemplary embodiments or aspects that are illustrated in the accompanying schematic figures, in which:

FIG. 1 is a cross-sectional side view of a first lid assembly in a retracted state, according to some non-limiting embodiments or aspects;

FIG. 2 is a cross-sectional side view of the lid assembly of FIG. 1 and a container of a blender system, according to some non-limiting embodiments or aspects;

FIG. 3 is a side view of a blender system, including the cross-sectional side view of the lid assembly and container FIG. 2, according to some non-limiting embodiments or aspects;

FIG. 4 is a cross-sectional side view of the first lid assembly in an extended state, according to some non-limiting embodiments or aspects;

FIG. 5 is a cross-sectional side view of the lid assembly of FIG. 4 and a container of a blender system, according to some non-limiting embodiments or aspects;

FIG. 6 is a close-up view of a restricted processing volume, according to some non-limiting embodiments or aspects;

FIG. 7 is a cross-sectional side view of a second lid assembly in a retracted state, according to some non-limiting embodiments or aspects;

FIG. 8 is a cross-sectional side view of the lid assembly of FIG. 7 and a container of a blender system, according to some non-limiting embodiments or aspects;

FIG. 9 is a side view of a blender system, including the cross-sectional side view of the lid assembly and container FIG. 8, according to some non-limiting embodiments or aspects;

FIG. 10 is a cross-sectional side view of the second lid assembly in an extended state, according to some non-limiting embodiments or aspects;

FIG. 11 is a cross-sectional side view of the lid assembly of FIG. 10 and a container of a blender system, according to some non-limiting embodiments or aspects;

FIG. 12 is a perspective view of a lower portion of a telescoping piston shaft and connected piston head, according to some non-limiting embodiments or aspects;

FIG. 13 is a schematic diagram of the blender system of FIG. 3, according to some non-limiting embodiments or aspects;

FIG. 14 is a schematic diagram of the blender system of FIG. 9, according to some non-limiting embodiments or aspects;

FIG. 15 is a diagram of one or more components, devices, and/or systems, according to some non-limiting embodiments or aspects; and

FIG. 16 is a flowchart of a method of operating a blender system including a lid assembly, according to some non-limiting embodiments or aspects.

### DESCRIPTION

For purposes of the description hereinafter, the terms “end”, “upper”, “lower”, “right”, “left”, “vertical”, “horizontal”, “top”, “bottom”, “lateral”, “longitudinal,” and derivatives thereof shall relate to non-limiting embodiments or aspects as they are oriented in the drawing figures. However, it is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects of the disclosed subject matter. Hence, specific dimensions and other physical characteristics related to the embodiments or aspects disclosed herein are not to be considered as limiting.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “server” may refer to or include one or more computing devices that are operated by or facilitate communication and processing for multiple parties in a network environment, such as the internet, although it will be appreciated that communication may be facilitated over one or more public or private network environments and that various other arrangements are possible. Further, multiple computing devices (e.g., servers, desktop computers, mobile devices, etc.) directly or indirectly communicating in the network environment may constitute a “system.” Reference to “a server” or “a processor,” as used herein, may refer to a previously recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

The devices, assemblies, systems, and methods herein provide numerous technical improvements in blender systems. In particular, a number of technical problems are directly addressed by the described configurations: scattering, cavitation, air exposure, and spoilage. Scattering may refer to the propelling of processed contents away from a blending apparatus (e.g., a blade assembly) and through the blender container along an overly long path, preventing efficient circulation due to contents traveling far from the blending apparatus and/or colliding with other ejected particles along the way. For example, scattering may be more common when blending small amounts and/or contents that form small particles or powders (e.g., coffee grounds, spices, etc.). Cavitation may refer to the inability for contents being processed to timely return to the blending apparatus after being propelled away from the blending apparatus, such that a cavity may form around the blending apparatus due to adhesion of the contents to the container and/or lid, due to cohesion among the contents, and/or a combination thereof. For example, cavitation may be more common when blending high-density and/or high-viscosity contents (e.g., bananas, avocado, crushed ice, nut butters, etc.).

Air exposure may refer to the presence of air in the blender container during or after processing of the contents. Air exposure may result in the promotion of scattering and/or cavitation, as compared to a processing volume that is under at least a partial vacuum. Air exposure may also result in a fourth technical problem: spoilage. Spoilage may refer to the deterioration of processed contents after being blended and stored in a blender container. Spoilage may be slowed by reducing the temperature of the stored contents, reducing the initial amount of air in the stored container, and/or preventing air flow into the container after storage. The described devices, assemblies, systems, and methods provide technical improvements that address at least the above-identified technical problems.

In some non-limiting embodiments or aspects, the described lid assembly may include a lid cover that engages an open end of a blender container, preventing ejection of food contents and creating a maximum upper boundary for both scattering and cavitation. The lid cover may also be configured to form at least a partial seal around the open end of the blender container, reducing air exposure and spoilage. In some non-limiting embodiments or aspects, the described lid assembly may include a telescoping piston shaft and a piston head connected to the lower end of the telescoping piston shaft, such that when the telescoping piston shaft is at least partially extended, the piston head restricts a processing volume of the container. The restriction of the processing volume by action of the telescoping piston helps reduce scattering and cavitation, and also reduces air exposure, which may further result in spoilage. In some non-limiting embodiments or aspects, the telescoping piston may include a shroud around at least one of the piston shaft segments, which may prevent food contents from clinging to the telescoping piston shaft and/or traveling into a piston cavity in the lid assembly, from which the telescoping piston extends. The telescoping piston is also an improvement over separate compacting tools, such as tampers or ramrods, which may come into contact with the blending apparatus during operation, or which may provide smaller and less precise compacting surface areas.

In some non-limiting embodiments or aspects, the piston head may be configured with a flexible seal along a perimetric edge of the piston head, to prevent fluid transfer across the edge of the piston head. Such a configuration reduces scattering and cavitation, particularly by preventing contents being processed from slipping past the piston head and out of the processing volume. Moreover, such a configuration reduces air exposure and spoilage by preventing undesired gaseous fluid transfer from the environment and into the volume where the contents are being stored. In some non-limiting embodiments or aspects, the piston head may further be configured with one or more valves that permit gaseous fluid transfer (e.g., the movement of gaseous or substantially gaseous matter, such as air) from a lower surface of the piston head and through an upper surface of the piston head. This may prevent pressure buildup below the piston head and/or create negative pressure in the processing volume (e.g., at least a partial vacuum). The reduction of air in the processing volume may help mitigate scattering and cavitation, as well as reduce air exposure and spoilage.

In some non-limiting embodiments or aspects, the mechanical power needed to extend and/or retract the telescoping piston may be at least partly provided by a motor positioned in or on the lid assembly. Motor-driven configurations may reduce the physical demand on users of blender systems and may be controlled by processors associated with the blender system, to allow for precise control of the extension and retraction of the telescoping piston. For example, if a processor detects that the telescoping piston has overly compacted the contents within the processing volume, the processor may control the motor to at least partly retract the telescoping piston. By way of further example, if the processor detects cavitation, the processor may control the motor to at least partly extend the telescoping piston. In view of the above, it will be appreciated that motor-driven configurations reduce user burden and offer precise machine control.

In some non-limiting embodiments or aspects, the mechanical power needed to extend and/or retract the telescoping piston may be at least partly provided by a handle positioned in or on the lid assembly, which may permit a user to rotate (e.g., crank) the handle and extend and/or retract the telescoping piston. Handle-driven configurations may reduce the need for electrical power to be supplied to the lid assembly of the blender system, which may reduce the need to charge a capacitor in the lid assembly or include an electrical connection from a base of the blender system to the lid assembly. In some non-limiting embodiments or aspects, the lid assembly may include, or be associated with, both a handle and a motor. A handle used in conjunction with a motor may allow the user to override the default motor-controlled settings and/or operate the telescoping piston where power cannot or should not be provided to the motor. Additionally, the motor may provide supplemental or overriding power to extend and/or retract the telescoping piston when the handle-drive power is insufficient or imprecisely applied.

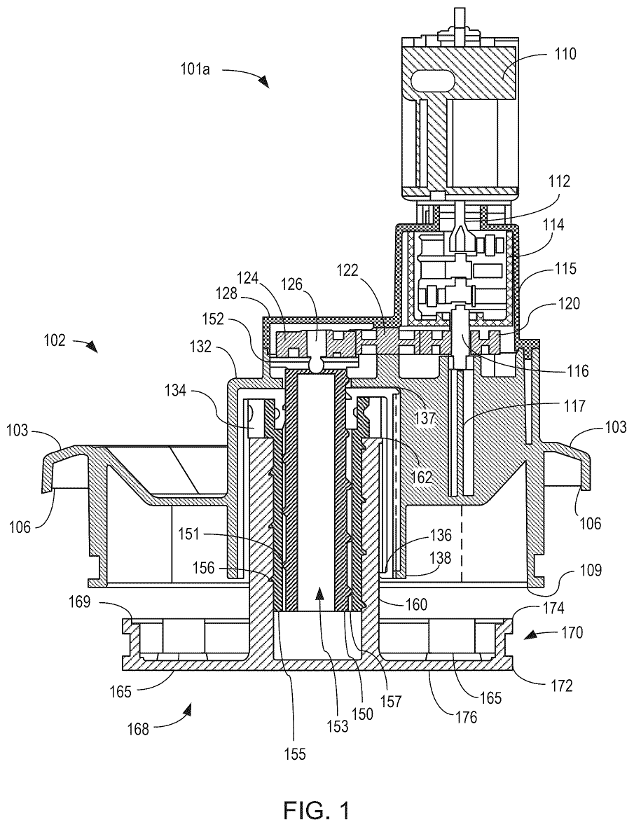

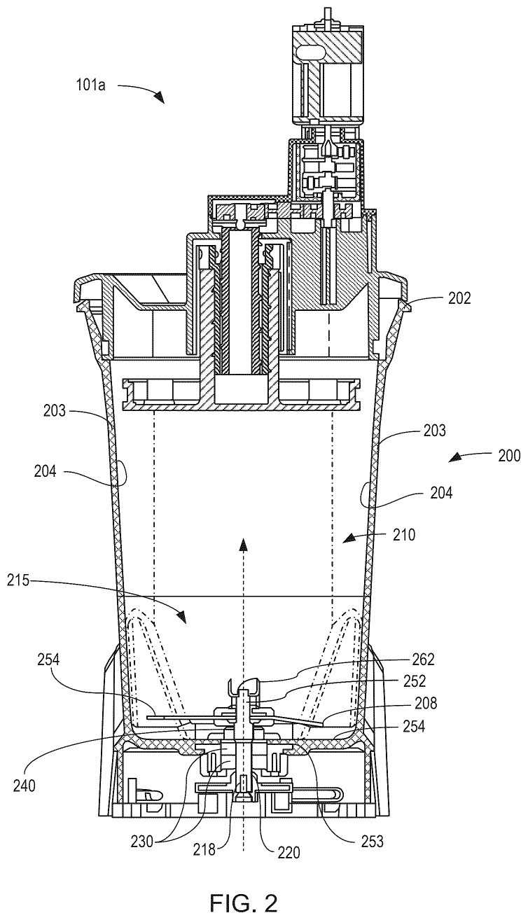

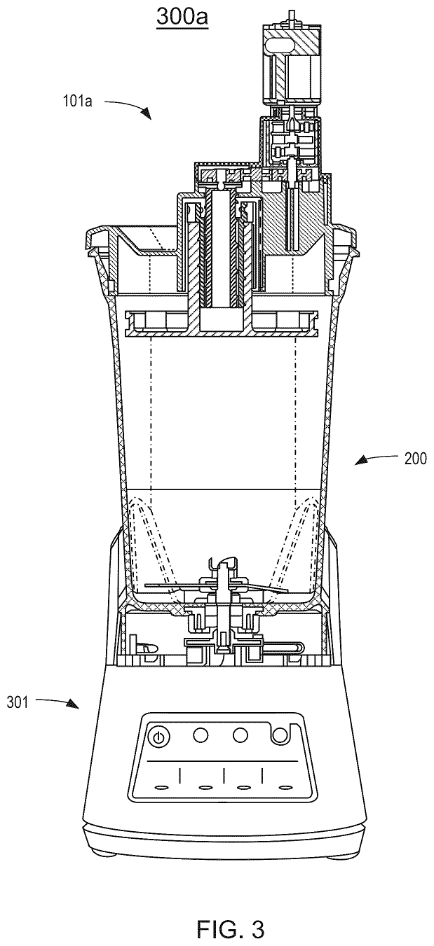

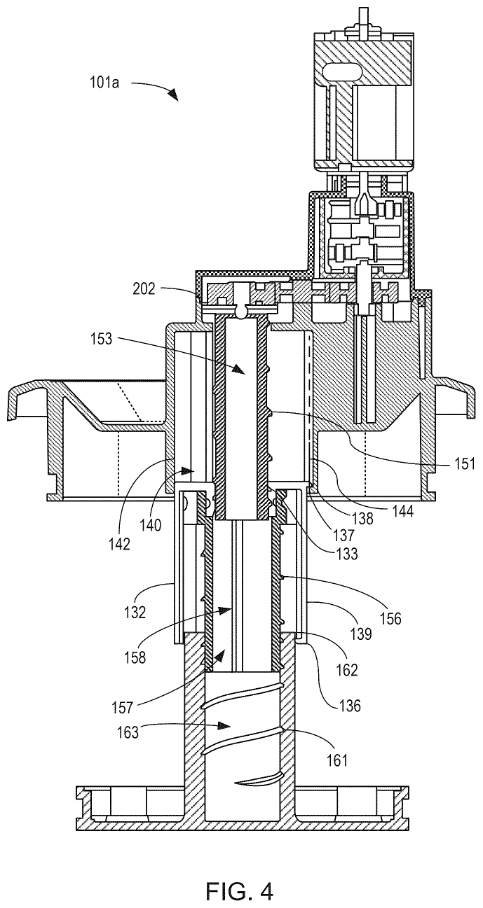

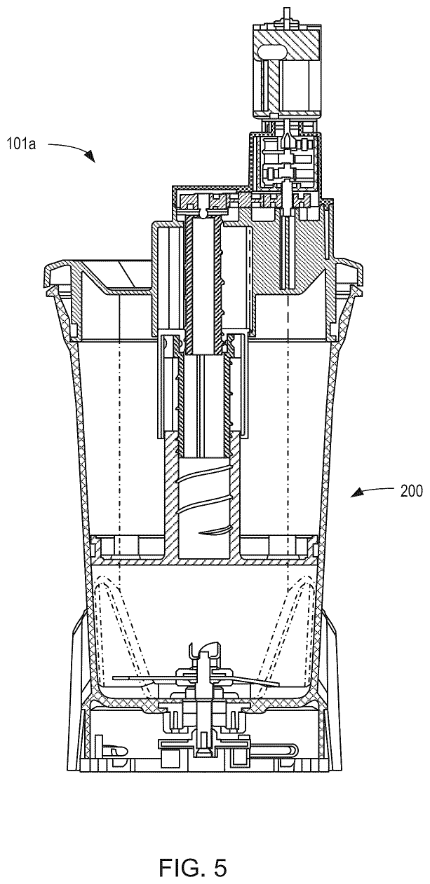

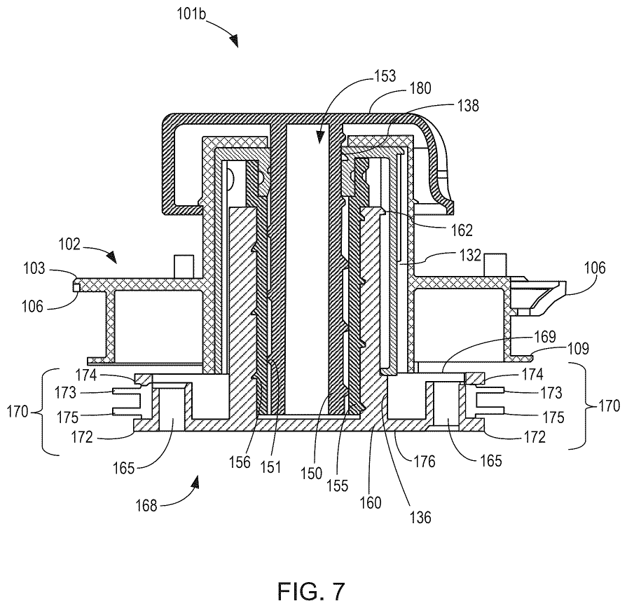

Referring now to FIGS. 1-5, FIGS. 1-5 are views of components of blender system 300a, including lid assembly 101a, container 200, and base 301, according to some non-limiting embodiments or aspects. For example, FIGS. 1-3 depict lid assembly 101a when telescoping piston shaft 307 is in a retracted state, and FIGS. 4 and 5 depict lid assembly 101a when telescoping piston shaft 307 is in an extended state. FIGS. 1 and 4 are cross-sectional side views of lid assembly 101a. FIGS. 2 and 5 are cross-sectional side views of lid assembly 101a engaged with container 200. FIG. 3 is a view of blender system 300a, including cross-sectional side views of lid assembly 101a engaged with container 200 atop a profile side view of base 301. Lid assembly 101a is depicted in FIGS. 1-5 with motor 110 to provide motorized power for extending and retracting telescoping piston shaft 307, however, lid assembly 101a may additionally or alternatively be configured with handle 180 to provide manual-drive power, as described herein (see, e.g., FIGS. 7-11).

With reference to FIGS. 1-5, lid assembly 101a may include lid cover 102 (e.g., a capping structure configured to at least partially enclose an open end of container 200). Lid cover 102 may be configured to engage an open end of container 200 of blender system 300a. Lid cover 102 may be formed of one or more lightweight and durable materials (e.g., plastic, aluminum, etc.) and may include flexible or semi-flexible portions thereof. Lid cover 102 may include flexible skirt 103 (e.g., a thinner extension of lid cover 102, such as a lip), which may be at least partly formed of a flexible material (e.g., rubber, synthetic rubber, plastic, etc.) to permit a lip of flexible skirt 103 to fit over and engage securely with container 200. Lid skirt 103 may include lid attachment surface 106 that is configured to engage with container attachment surface 202, to hold lid assembly 101a in place atop container 200. In some non-limiting embodiments or aspects, container 200 may have a form of a cylinder, a rounded prism, or another columnar geometry, such as a pitcher-shape. As used herein, container 200 contains contents (e.g., food, liquid, spices, coffee, ice, or other processable material) to be processed (e.g., blended, mixed, chopped, crushed, pureed, and/or the like).

Lid cover 102 may further include bottom surface 109, which may be configured as a second engagement point with container 200. Bottom surface 109 may at least partly include a plane orthogonal to central axis 257, which may include a lip or rim of bottom surface 109 that engages with container 200. Container 200 may include ledge 207 that is configured to contact and support bottom surface 109 of lid cover 102. As such, bottom surface 109 may act as an upper limit on the total available contents-containing volume 210 of container 200.

In some non-limiting embodiments or aspects, lid assembly 101a may include motor 110 (e.g., a universal motor, a direct current (DC) motor (e.g., a brushless DC motor, a series-wound DC motor, etc.), a step motor, and/or the like). Motor 110 may be configured to provide the mechanical power necessary to extend and retract telescoping piston shaft 307. For example, motor 110 may include or be mechanically connected to motor drive shaft 112, which may rotate clockwise or counterclockwise based on the rotation output by motor 110. Motor drive shaft 112 may be connected to a gearbox, such as worm gear reducer 114. The gear ratio of worm gear reducer 114 may be configured such that the output torque and/or speed of motor 110 may safely act on a gear assembly, which may transfer the power from motor 110 to the telescoping piston shaft 307. Worm gear reducer 114 may be wholly or partly enclosed in casing 115. Gear assembly, including, for example, first gear 120, second gear 122, and third gear 124, may be wholly or partly enclosed in gear assembly housing 128. Casing 115 and gear assembly housing 128 may be formed from a coextensive enclosure.

The mechanical power from motor 110 may be adjusted by worm gear reducer 114 before being output via gear drive shaft 116. Gear drive shaft 116 may be mounted on and/or engaged with gear drive shaft receiver 117, to prevent gear drive shaft 116 from tilting off-axis. Gear drive shaft 116 may be connected to first gear 120, and the rotation of gear drive shaft 116 may cause first gear 120 to rotate with the same rotational velocity. First gear 120 may be rotatably meshed with second gear 122, such that the rotation of first gear 120 causes second gear 122 to rotate. Furthermore, second gear 122 may be rotatably meshed with third gear 124, such that the rotation of second gear 122 causes third gear 124 to rotate. Third gear 124 may be connected to piston drive shaft 126, such that the rotation of third gear 124 causes piston drive shaft 126 to rotate. Piston drive shaft 126 may be connected to flange 152 of first piston shaft 150, such that the rotation of piston drive shaft 126 causes first piston shaft 150 to rotate along central axis 257.

In some non-limiting embodiments or aspects, lid assembly 101a may include telescoping piston shaft 307 (e.g., a nested series of columnar support structures configured to segmentally expand and retract), which may include two or more piston shaft segments. The end of telescoping piston shaft 307 may include and/or be connected to piston head 168 (e.g., a substantially planar structure for confining, tamping, and/or cordoning a volume in container 200). As shown in FIGS. 1-5, lid assembly 101a includes a telescoping piston shaft 307 with three piston shaft segments, including first piston shaft segment 150, second piston shaft segment 155, and third piston shaft segment 160. However, it will be appreciated that telescoping may be achieved under the same configuration for only two piston shaft segments, or four or more piston shaft segments. Piston shaft segments 150, 155, 160 of telescoping piston shaft 307 may be nested, one inside the other, such that each piston shaft segment may fit at least partly inside the preceding segment. For example, first piston shaft segment 150 may be at least partially positioned inside second piston shaft segment 155. Furthermore, second piston shaft segment 155 may be at least partially positioned inside third piston shaft segment 160.

In some non-limiting embodiments or aspects, the telescoping action may be carried out by sliding each segment of telescoping piston shaft 307 along an adjacent piston shaft segment. As depicted, telescoping piston shaft 307 telescopically extends along central axis 257 through a rotational driving action, beginning with first piston shaft segment 150. For example, the mechanical power may be transferred from motor 110, through the gear assembly of first gear 120, second gear 122, and third gear 124, and into piston drive shaft 126. The rotational motion may thereby be imparted into first piston shaft segment 150 via a mechanical connection to piston drive shaft 126, such as via flange 152. First piston shaft segment 150 may include first external threading 151 on an exterior surface of first piston shaft segment 150. As shown, first external threading 151 may be threadedly engaged with first internal threading 133 of piston shroud 132, which may cover second piston shaft segment 155. It will be appreciated, however, that in embodiments without a piston shroud, first external threading 151 of first piston shaft segment 150 may directly engage with an internal threading of second piston shaft segment 155. Piston shroud 132 may be configured dimensionally to fit closely with the shape of piston cavity 140, to prevent foreign matter from entering piston cavity.

In some non-limiting embodiments or aspects, piston shroud 132 may be prevented from rotating about central axis 257, so that the rotational motion of first piston shaft segment 150 is translated into a linear translation of piston shroud 132 in a direction parallel to central axis 257. In other words, the engagement of first external threading 151 with first internal threading 133 may be mechanically transferred into a linear force by preventing piston shroud 132 from rotating. For example, piston shroud 132 may include upper detent 137 that is received at least partly in receiving channel 144, and receiving channel 144 may be formed in or on an interior wall of lid assembly 101a that at least partly forms piston cavity 140. Upper detent 137 may fit into receiving channel 144, thereby preventing rotational movement of piston shroud 132. In this manner, as first piston shaft segment 150 rotates in a first direction, first external threading 151 may push against first internal threading 133, which may cause piston shroud 132 to translate downward. As piston shroud 132 translates downward, upper detent 137 may slide along receiving channel 144. When piston shroud 132 has translated to its furthest extent, upper detent 137 may come into contact with lower detent 138, which extends from an inner wall of lid assembly 101a that at least partly forms piston cavity 140. Lower detent 138 may prevent upper detent 137 from leaving receiving channel 144, and thereby may prevent piston shroud 132 from translating any farther down. It will be appreciated that additional channels may be provided in or on the interior wall of piston cavity 140, and those additional channels may be configured to receive additional detents extending from piston shroud 132, to add additional mechanical redundancies.

In some non-limiting embodiments or aspects, as piston shroud 132 is translated downward, second piston shaft segment 155, which is positioned in piston shroud 132, may likewise be translated downward due to a downward force imparted on second piston shaft segment 155 by piston shroud 132. So that the telescoping action may continue along telescoping piston shaft 307, second piston shaft segment 155 may be mechanically engaged with first piston shaft segment 150, such that the rotation of first piston shaft segment 150 is imparted upon second piston shaft segment 155. For example, first piston shaft segment 150 may include a detent (not shown), similar to upper detent 137, that extends into receiving channel 158 of second piston shaft segment 155. Receiving channel 158 may be formed on or in second piston shaft interior 153. As second piston shaft segment 155 is translated downward, first piston shaft segment 150 partly may emerge from within second piston shaft segment 155, and the detent for first piston shaft segment 150 may slidably engage along receiving channel 158. The rotation of first piston shaft segment 150 may further be imparted by the detent of first piston shaft segment 150 into the sidewall of receiving channel 158, which causes second piston shaft segment 155 to rotate in the same direction as first piston shaft segment 150.

In some non-limiting embodiments or aspects, the rotation of second piston shaft segment 155 may be further imparted on third piston shaft segment 160, which may cause third piston shaft segment 160 to translate in a direction parallel to central axis 257. For example, second piston shaft segment 155 may include second external threading 156, which may be configured to threadedly engage with second internal threading 161 in or on interior surface 163 of third piston shaft segment 160. Third piston shaft segment 160 may be prevented from rotating using the same mechanical principles as piston shroud 132. For example, third piston shaft segment 160 may include upper detent 162, which may fit at least partly into receiving channel 139 formed in or on an inner surface of piston shroud 132. As the rotational force of second piston shaft segment 155 acts upon third piston shaft segment 160 due to the threaded engagement of second external threading 156 with second internal threading 161, third piston shaft segment 160 may be prevented from rotating due to upper detent 162 extending at least partly into receiving channel 139. This may allow the rotational force of second piston shaft segment 155 to push third piston shaft segment 160 away from second piston shaft segment, the vertical translation of which may be guided by the sliding of upper detent 162 along receiving channel 139. It will be appreciated that additional channels may be provided in or on the interior wall piston shroud 132, and those additional channels may be configured to receive additional detents extending from third piston shaft segment 160, to add additional mechanical redundancies.

In some non-limiting embodiments or aspects, the mechanical engagement between first piston shaft segment 150 and second piston shaft segment 155 may cause first piston shaft segment 150 and second piston shaft segment 155 to rotate at the same rotational velocity. However, the rate of translation of piston shroud 132, second piston shaft segment 155, and third piston shaft segment 160 may be determined at least partly by the lead of the respective threading groups (e.g., a measure of how quickly the threading descends along an axis of rotation), including the pairing of first external threading 151 with first internal threading 133, and the pairing of second external threading 156 with second internal threading 161. For example, the higher the lead of a threading group, the faster the linear translation may be with each degree of rotation. By way of further example, if one threading group has a lead of 1 centimeter (cm), and a second threading group has a lead of 2 cm, the linear translation imparted by the threading group with a lead of 2 cm may be twice as fast as the linear translation imparted by the threading group with a lead of 1 cm.

In some non-limiting embodiments or aspects, piston head 168 may be connected to (e.g., formed coextensively with, attached to, extended from, etc.) a lower end of telescoping piston shaft 307. For example, piston head 168 may be connected to a lower end of third piston shaft segment 160. Piston head 168 may have a lower surface 176 (e.g., including an at least partly planar face) that faces the bottom of container 200 and acts as an upper limit on processing volume 215 of container 200. When telescoping piston shaft 307 telescopically extends, piston head 168 may be moved linearly toward a bottom surface 208 of container 200, along central axis 257. If container 200 contains a sufficient volume of contents to be processed, the downward movement of piston head 168 may act to compress and shift the contents closer to blade assembly 306, thereby shrinking processing volume 215. If container 200 contains a smaller amount of contents to be processed, the lowered piston head 168 may act to eliminate unnecessary head space above blade assembly 306.

In some non-limiting embodiments or aspects, piston head 308 may include one or more valves 165 (e.g., one-way valves, electronically controlled valves, etc.) that may selectively permit gaseous fluid transfer from bottom surface 176, through the body of piston head 168, and through upper surface 169 of piston head 168. For example, as piston head 168 moves downward and comes into contact with the inner walls 204 of container 200, piston head 168 may create at least a partial seal and separate the processing volume 215 of container 200 from the remainder of the contents-containing volume 210. This sealed processing volume 215 might increase in pressure if air captured below the piston head 168 were not allowed to escape. As such, one or more valves 165 in piston head 168 may permit gaseous fluid transfer through piston head 168, preventing pressure building below piston head 168. Additionally, or alternatively, one or more valves 165 in piston head 168 may be configured to create a negative pressure below piston head 168, removing further air and creating a suction within processing volume 215.

In some non-limiting embodiments or aspects, a perimetric edge (e.g., a distal rim, a circumferential border, etc.) of piston head 168 may include (e.g., be connected to, have affixed, etc.) flexible seal 170, which may be formed of a flexible, fluid-impermeable material (e.g., rubber, synthetic rubber, plastic, silicone, etc.). Flexible seal 170 may include and/or be bounded by upper section 174 and lower section 172. When telescoping piston shaft 307 is fully retracted, piston head 168 may not be in contact with inner walls 204 of container 200. When telescoping piston shaft 307 is at least partially extended, piston head 168 may come into contact with inner walls 204 at the point of flexible seal 170, along the perimetric edge of piston head 168. Inner walls 204 of container 200 may be substantially vertically oriented but may include a slight inward taper from top to bottom of container 200. In this manner, more of flexible seal 170 may come into contact with inner walls 204 as piston head 168 is lowered further toward bottom surface 208 of container 200.

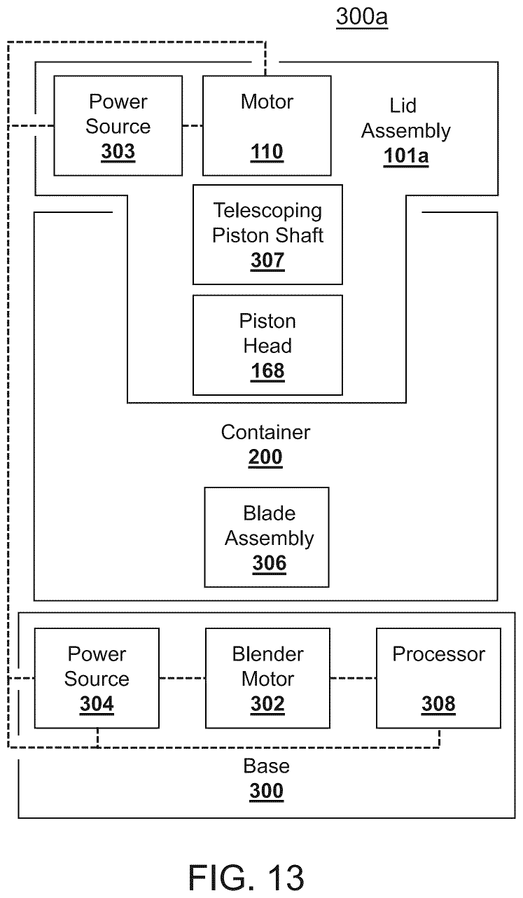

With reference to FIG. 3, FIG. 3 depicts blender system 300a including lid assembly 101a (including telescoping piston shaft 307), container 200 (including blade assembly 306), and base 301. The depicted base 301 is provided for illustrative purposes but is not to be taken as limiting on possible configurations for blender system 300a. Base 301 is shown in profile side view, while lid assembly 101a and container 200 are shown in cross-sectional side view. In some non-limiting embodiments or aspects, the contents and configuration of blender system 300a, including base 301, may be as described herein (see, e.g., FIG. 13).

In some non-limiting embodiments or aspects, blender system 300a may include base 301. Base 301 may include a power source (e.g., a battery, a power converter with further connection to an external outlet, etc.) (see, e.g., power source 304 of FIG. 13) for powering a blender motor (see, e.g., blender motor 302 of FIG. 13), which may provide the mechanical power for driving blade assembly 306. Base 301 may further include a processor (see, e.g., processor 308 of FIG. 13) configured to control and/or communicate with, at least partly, a user interface of base 301 (e.g., buttons, dials, sliders, touchscreen, switches, etc.). The processor of base 301 may further provide at least partial automatic control to the blender motor, motor 110 of lid assembly 101a, and one or more power sources in blender system 300a, including the power source in base 301 and any power sources in lid assembly 101a. In some non-limiting embodiments or aspects, telescoping piston shaft 307 may be at least partly controlled (e.g., caused to telescopically extend and/or retract) by instructions (e.g., signals) sent from the processor of base 301. Electrical power and/or signals may be transmitted from base 301 to lid assembly 101a at least partly through wiring in handle 201 of container 200.

In some non-limiting embodiments or aspects, a user may direct a series of steps to cause blender system 300a to efficiently process contents in container 200. The following illustrative scenario may have a starting configuration with container 200 atop base 301, with lid assembly 101a removed. The user may place contents to be processed (e.g., food, such as fruit for a smoothie) in container 200. The user may place lid assembly 101a atop container 200, assuring that lid cover 102 (e.g., lid skirt 102 and/or bottom surface 109) is securely in contact with container attachment surface 202. The user may activate motor 110 in a first motor direction, by activating a control in lid assembly 101a (e.g., a button, a switch, etc.) and/or interacting with a user interface of base 301. In response, motor 110 may cause telescoping piston shaft 307 to at least partly telescopically extend toward bottom surface 208 of container 200. In this manner, piston head 168 may create restricted processing volume 215, to promote more efficient processing of the contents. Motor 110 may be configured to stop automatically in response to reaching the fullest extension of telescoping piston shaft 307, in response to mechanical resistance in the force required to extend telescoping piston shaft 307, in response to user input, and/or the like.

In some non-limiting embodiments or aspects, the user may activate a processing function of blender system 300a, such as by interacting with the user interface of base 301. For example, the user may select a “Low” speed setting button, which may cause a blender motor of base 301 to activate, and which may cause blade assembly 306 to rapidly spin. As blade assembly 306 rapidly spins, the contents being processed may be prevented from scattering or cavitating due to restricted processing volume 215. When sufficient processing has occurred, the motor in base 301 may be deactivated, either automatically by an onboard processor or in response to user control. Likewise, the motor 110 may be activated in a second motor direction, either automatically or in response to user control. In response, motor 110 may cause telescoping piston shaft 307 to at least partly telescopically retract from bottom surface 208 of container 200. Motor 110 may be configured to stop automatically in response to reaching the fullest retraction of telescoping piston shaft 307, in response to mechanical resistance in the force required to retract telescoping piston shaft 307, in response to user input, and/or the like. The user may then remove lid assembly 101a from container 200 or open an access panel in lid assembly 101a to retrieve the processed contents from container 200.

With reference to FIGS. 4 and 5, FIGS. 4 and 5 depict lid assembly 101a with telescoping piston shaft 307 in a fully extended state. To achieve telescopic extension, motor 110 may activate in a first motor direction, which may cause motor drive shaft 112 to rotate, which may cause gear drive shaft 116 to rotate via worm gear reducer 114, which may cause first gear 120 to rotate, which may cause second gear 122 to rotate, which may cause third gear 124 to rotate, which may cause piston drive shaft 126 to rotate, which may cause first piston shaft segment 150 to rotate in a first rotation direction (via flange 152), which may cause piston shroud 132 to translate downward, which may cause second piston shaft segment 155 to translate downward. Furthermore, the rotation of first piston shaft segment 150 in the first rotation direction may cause second piston shaft segment 155 to rotate in the first rotation direction as well, which may cause third piston shaft segment 160 to translate downward. This transference of rotation and movement may result in second piston shaft segment 155 slidably extending downward away from the position of first piston shaft segment 150, and may result in third piston shaft segment 160 slidably extending downward away from the position of both first piston shaft segment 150 and second piston shaft segment 155. The movement of third piston shaft segment 160 may cause piston head 168 to translate downward as well.

In some non-limiting embodiments or aspects, to achieve telescopic retraction, motor 110 may activate in a second motor direction opposite the first motor direction, which may cause motor drive shaft 112 to rotate, which may cause gear drive shaft 116 to rotate via worm gear reducer 114, which may cause first gear 120 to rotate, which may cause second gear 122, which may cause third gear 124 to rotate, which may cause piston drive shaft 126 to rotate, which may cause first piston shaft segment 150 to rotate in a second rotation direction opposite the first rotation direction (via flange 152), which may cause piston shroud 132 to translate upward, which may cause second piston shaft segment 155 to translate upward. Furthermore, the rotation of first piston shaft segment 150 in the second rotation direction may cause second piston shaft segment 155 to rotate in the second rotation direction as well, which may cause third piston shaft segment 160 to translate upward. This transference of rotation and movement may result in second piston shaft segment 155 slidably retracting upward into the first piston shaft segment 150, and may result in third piston shaft segment 160 slidably retracting upward into the second piston shaft segment 155. The movement of the third piston shaft segment 160 may also cause piston head 168 to translate upward as well.

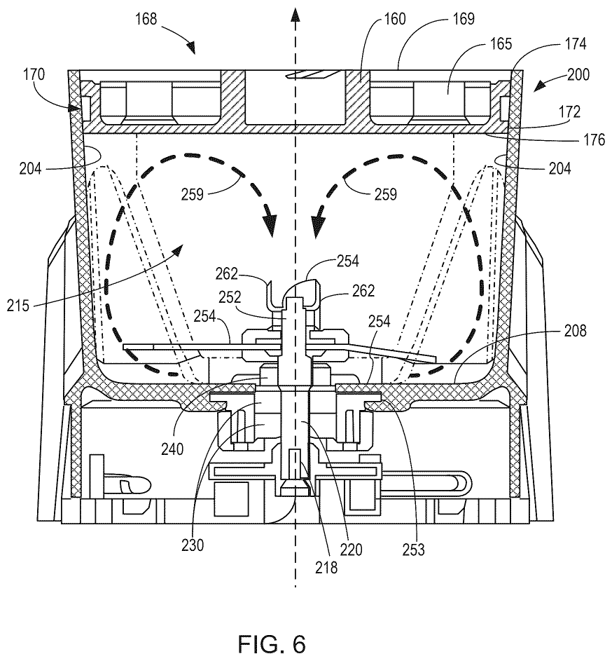

Referring now to FIG. 6, FIG. 6 is a close-up view of blade assembly 306 and restricted processing volume 215 in container 200, according to non-limiting embodiments or aspects of the present disclosure. In particular, FIG. 6 is a close-up view of blade assembly 306 and restricted processing volume 215 in the bottom portion of FIG. 5, and restricted processing volume 215 may be a volume bounded by lower surface 176 of piston head 168, one or more walls 204 of container 200, and bottom surface 208 of container 200. Restricted processing volume 215 may be created when lid assembly 101a or lid assembly 101b is in at least a partially extended state, as shown in FIGS. 4, 5, 10, and 11. As shown, blade assembly 306 may include, but is not limited to, blade drive shaft 218, blade support shaft 220, one or more bearings 230, lip seal 240, hub 252, foundation 253, one or more cutting blades 254, and one or more crushing blades 262. It will be appreciated that the depicted restricted processing volume 215 may be formed via either lid assembly 101a or lid assembly 101b.

In some non-limiting embodiments or aspects, blade assembly 306 may receive blending power from a motor contained in base 301 of blender system 300a (see, e.g., FIG. 3). The motor may cause blade drive shaft 218 to rotate about central axis 257. Blade drive shaft 218 may be connected to blade support shaft 220, upon which may be connected hub 252. The rotation of blade drive shaft 218 may cause blade support shaft 220 to rotate about central axis 257, which may cause hub 252 to rotate about central axis 257. The various blades used to process contents in container 200 may be connected to hub 252. For example, blade assembly 306 may include one or more cutting blades 254, which may be configured to process contents by slicing and chopping. By way of further example, blade assembly 306 may include one or more crushing blades 262, which may be configured to process contents by crushing and shattering. The rotation of blade assembly 306, with enough speed, may disintegrate, mix, and blend contents in container 200.

In some non-limiting embodiments or aspects, blade support shaft 220 may be encircled by one or more bearings 230 (e.g., ball bearings), which may be configured to allow blade support shaft 220 to rotate with minimized resistance due to the low-friction interface of bearings 230. Above the one or more bearings, and just inside container 200 along bottom surface 208, blade assembly 306 may include lip seal 240. Lip seal 240 may be configured to separate the processing area within container 200 from the gap in bottom surface 208 through which blade support shaft 220 extends. Lip seal 240 may prevent contents from escaping through bottom surface 208. Moreover, blade assembly 306 may include foundation 253 that is configured to encircle bearings 230, to fixedly seat blade assembly 306 in place at the bottom of container 200.

In some non-limiting embodiments or aspects, the rotational motion of blade assembly 306, particularly through rotation of cutting blades 254, may cause contents in the plane of cutting blades 254 to be propelled away from hub 252 and toward inner walls 204 of container 200. In some ideal processing scenarios, the force of blade assembly 306 propelling contents outward to inner walls 204 may create cyclical food-processing flow path 259, in which contents are pushed outward toward walls 204, pushed further upward along walls 204, and fall/rebound back toward central axis 257 to be pulled back down toward blade assembly 306. However, contents being processed may fail to follow cyclical food-processing flow path 259, such as due to scattering or cavitation. The failure of contents to follow cyclical food-processing flow path 259 may result in inefficient processing.

The described lid assembly 101a directly supports a proper flow of contents along cyclical food-processing flow path 259. For example, by providing a maximum ceiling on restricted processing volume 215 via lower surface 176 of piston head 168, the contents being processed cannot scatter as far away from blade assembly 306, and instead, such contents may be repelled back toward blade assembly 306 after colliding with piston head 168. Furthermore, restricted processing volume 215 bounded by piston head 168 may reduce the available air space for cavitation to form in the contents being processed, allowing at least some portion of the contents to maintain contact with blade assembly 307 throughout processing, which promotes proper cycling. It will be appreciated that flexible seal 170 positioned on the perimetric edge of piston head 168 and contacting inner walls 204 prevents contents from escaping restricted processing volume 215. It will also be appreciated that by sealing off restricted processing volume 215 using flexible seal 170, and allowing air pressure to be released and/or removed from restricted processing volume 215 via one or more valves 165 in piston head 168, scattering, cavitation, air exposure, and spoilage can be mitigated.

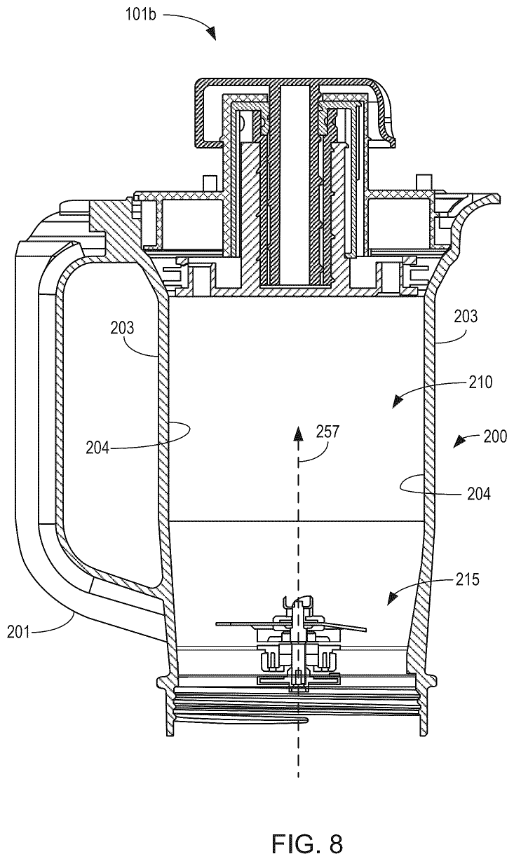

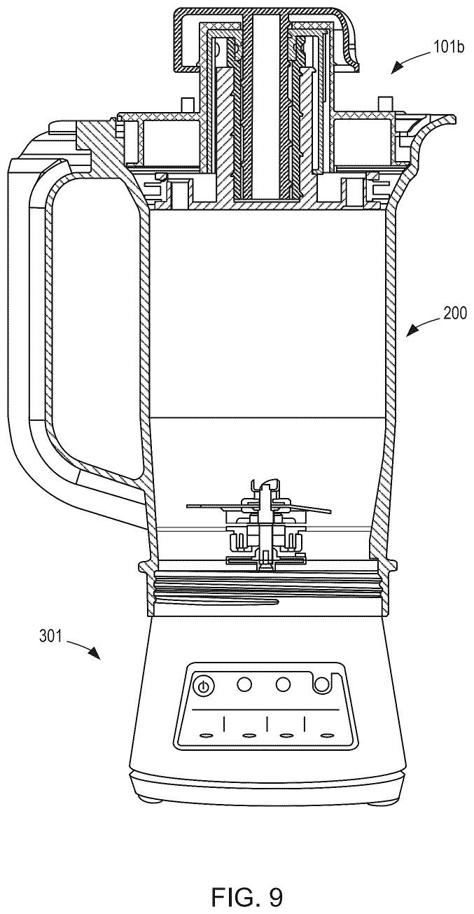

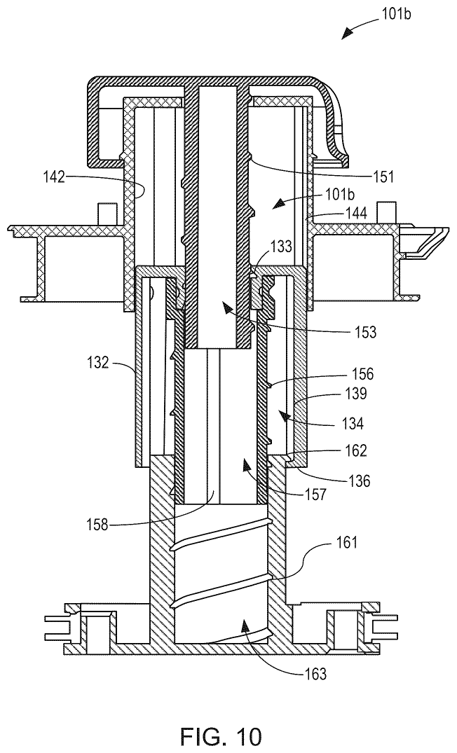

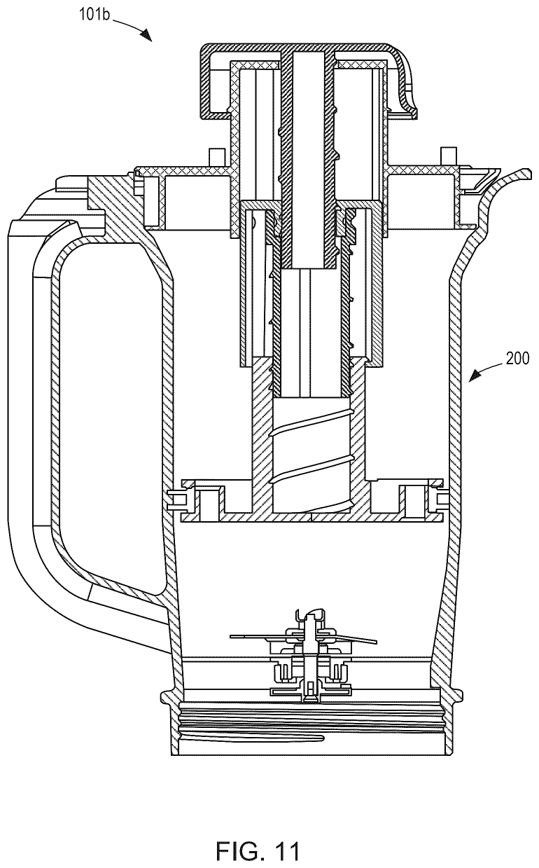

Referring now to FIGS. 7-11, FIGS. 7-11 are views of components of blender system 300b, including lid assembly 101b, container 200, and base 301, according to non-limiting embodiments or aspects of the present disclosure. In particular, FIGS. 7-9 depict lid assembly 101b when telescoping piston shaft 307 is in a retracted state, and FIGS. 10 and 11 depict lid assembly 101b when telescoping piston shaft 307 is in an extended state. FIGS. 7 and 10 are cross-sectional side views of lid assembly 101b. FIGS. 8 and 11 are cross-sectional side views of lid assembly 101b engaged with container 200. FIG. 9 is a view of blender system 300b, including cross-sectional side views of lid assembly 101b engaged with container 200 atop a profile side view of base 301. Lid assembly 101b is depicted in FIGS. 7-11 with handle 180 to provide manual-driven power for extending and retracting telescoping piston shaft 307, however, lid assembly 101b may additionally or alternatively be configured with motor 110 to provide motorized power (see FIGS. 1-5). The same material, mechanical, and dimensional design considerations described above in connection with the fit of lid assembly 101a on container and the movement of telescoping piston shaft 307 may be applied to lid assembly 101b, particularly in connection with lid cover 102, flexible skirt 103, bottom surface 109, first piston shaft segment 150, second piston shaft segment 155, third piston shaft segment 160, piston shroud 132, piston cavity 140, piston head 168, and their component parts.

With reference to FIGS. 7-11, lid assembly 101b may include lid cover 102. Lid cover 102 may be configured to engage an open end of container 200 of blender system 300b. Lid cover 102 may include flexible skirt 103 configured to fit over and engage securely with container 200. Lid skirt 103 may include lid attachment surface 106 that is configured to engage with container attachment surface 202, to hold lid assembly 101b in place atop container 200. Lid cover 102 may further include bottom surface 109, which may be configured as a second engagement point with container 200. Bottom surface 109 may at least partly include a plane orthogonal to central axis 257, which may include a lip or rim of bottom surface 109 that engages with container 200. Container 200 may include ledge 207 that is configured to contact and support bottom surface 109 of lid cover 102. As such, bottom surface 109 may act as an upper limit on the total available contents-containing volume 210 of container 200.

In some non-limiting embodiments or aspects, lid assembly 101b may include handle 180, configured for a user to grip the handle and rotate the handle clockwise or counterclockwise about central axis 257. Handle 180, when manipulated by the user, may be configured to provide the mechanical power necessary to extend and retract telescoping piston shaft 307. For example, handle 180 may be formed coextensively with, or may be mechanically connected to, first piston shaft segment 150. In that manner, the rotation of handle 180 may cause first piston shaft segment 150 to rotate in the same direction.

In some non-limiting embodiments or aspects, lid assembly 101b may include telescoping piston shaft 307, which may include two or more piston shaft segments. As shown in FIGS. 7-11, lid assembly 101b includes telescoping piston shaft 307 with three piston shaft segments, including first piston shaft segment 150, second piston shaft segment 155, and third piston shaft segment 160. However, it will be appreciated that telescoping may be achieved under the same configuration for only two piston shaft segments, or four or more piston shaft segments. Piston shaft segments 150, 155, 160 of telescoping piston shaft 307 may be nested, one inside the other, such that each piston shaft segment may fit at least partly inside the preceding segment. For example, first piston shaft segment 150 may be at least partially positioned inside second piston shaft segment 155. Furthermore, second piston shaft segment 155 may be at least partially positioned inside third piston shaft segment 160.

In some non-limiting embodiments or aspects, the telescoping action may be carried out by sliding each segment of telescoping piston shaft 307 along an adjacent piston shaft segment. As depicted, telescoping piston shaft 307 telescopically extends along central axis 257 through a rotational driving action, beginning with first piston shaft segment 150. For example, the mechanical power may be transferred from handle 180 into first piston shaft segment 150. First piston shaft segment 150 may include first external threading 151 on an exterior surface of first piston shaft segment 150. As shown, first external threading 151 may be threadedly engaged with first internal threading 133 of piston shroud 132, which may cover second piston shaft segment 155. It will be appreciated, however, that in embodiments without a piston shroud, first external threading 151 of first piston shaft segment 150 may directly engage with an internal threading of second piston shaft segment 155.

In some non-limiting embodiments or aspects, piston shroud 132 may be prevented from rotating about central axis 257, so that the rotational motion of first piston shaft segment 150 is translated into a linear translation of piston shroud 132 in a direction parallel to central axis 257. In other words, the engagement of first external threading 151 with first internal threading 133 may be mechanically transferred into a linear force by preventing piston shroud 132 from rotating. For example, piston shroud 132 may include upper detent 137 that is received at least partly in receiving channel 144, and receiving channel 144 may be formed in or on an interior wall of lid assembly 101b that at least partly forms piston cavity 140. Upper detent 137 may fit into receiving channel 144, thereby preventing rotational movement of piston shroud 132. In this manner, as first piston shaft segment 150 rotates in a first direction, first external threading 151 may push against first internal threading 133, which may cause piston shroud 132 to translate downward. As piston shroud 132 translates downward, upper detent 137 may slide along receiving channel 144. When piston shroud 132 has translated to its furthest extent, upper detent 137 may come into contact with lower detent 138, which extends from an inner wall of lid assembly 101a that at least partly forms piston cavity 140. Lower detent 138 may prevent upper detent 137 from leaving receiving channel 144, and thereby may prevent piston shroud 132 from translating any farther down. It will be appreciated that additional channels may be provided in or on the interior wall of piston cavity 140, and those additional channels may be configured to receive additional detents extending from piston shroud 132, to add additional mechanical redundancies.

In some non-limiting embodiments or aspects, as piston shroud 132 is translated downward, second piston shaft segment 155, which is positioned in piston shroud 132, may likewise be translated downward due to a downward force imparted on second piston shaft segment 155 by piston shroud 132. So that the telescoping action may continue along telescoping piston shaft 307, second piston shaft segment 155 may be mechanically engaged with first piston shaft segment 150, such that the rotation of first piston shaft segment 150 is imparted upon second piston shaft segment 155. For example, first piston shaft segment 150 may include a detent (not shown), similar to upper detent 137, that extends into receiving channel 158 of second piston shaft segment 155. Receiving channel 158 may be formed on or in second piston shaft interior 153. As second piston shaft segment 155 is translated downward, first piston shaft segment 150 partly may emerge from within second piston shaft segment 155, and the detent for first piston shaft segment 150 may slidably engage along receiving channel 158. The rotation of first piston shaft segment 150 may further be imparted by the detent of first piston shaft segment 150 into the sidewall of receiving channel 158, which causes second piston shaft segment 155 to rotate in the same direction as first piston shaft segment 150.

In some non-limiting embodiments or aspects, the rotation of second piston shaft segment 155 may be further imparted on third piston shaft segment 160, which may cause third piston shaft segment 160 to translate in a direction parallel to central axis 257. For example, second piston shaft segment 155 may include second external threading 156, which may be configured to threadedly engage with second internal threading 161 in or on interior surface 163 of third piston shaft segment 160. Third piston shaft segment 160 may be prevented from rotating using the same mechanical principles as piston shroud 132. For example, third piston shaft segment 160 may include upper detent 162, which may fit at least partly into receiving channel 139 formed in or on an inner surface of piston shroud 132. As the rotational force of second piston shaft segment 155 acts upon third piston shaft segment 160 due to the threaded engagement of second external threading 156 with second internal threading 161, third piston shaft segment 160 may be prevented from rotating due to upper detent 162 extending at least partly into receiving channel 139. This may allow the rotational force of second piston shaft segment 155 to push third piston shaft segment 160 away from second piston shaft segment, the vertical translation of which may be guided by the sliding of upper detent 162 along receiving channel 139. It will be appreciated that additional channels may be provided in or on the interior wall piston shroud 132, and those additional channels may be configured to receive additional detents extending from third piston shaft segment 160, to add additional mechanical redundancies.

In some non-limiting embodiments or aspects, piston head 168 may be connected to (e.g., formed coextensively with, attached to, extended from, etc.) a lower end of telescoping piston shaft 307. For example, piston head 168 may be connected to a lower end of third piston shaft segment 160. Piston head 168 may have a lower surface 176 (e.g., including an at least partly planar face) that faces the bottom of container 200 and acts as an upper limit on processing volume 215 of container 200. Piston head 308 may include one or more valves 165 (e.g., one-way valves, electronically controlled valves, etc.) that may selectively permit gaseous fluid transfer from bottom surface 176, through the body of piston head 168, and through upper surface 169 of piston head 168.

In some non-limiting embodiments or aspects, a perimetric edge (e.g., a distal edge, a circumferential edge, etc.) of piston head 168 may include (e.g., be connected to, have affixed, etc.) flexible seal 170, which may be formed of a flexible, fluid-impermeable material (e.g., rubber, synthetic rubber, plastic, silicone, etc.). Flexible seal 170 may include and/or be bounded by upper section 174 and lower section 172. Flexible seal 170 may further include one or more flexible rings encompassing piston head 168, including upper flexible ring 173 and lower flexible ring 175. Flexible rings 173, 175 may be formed of a flexible, impermeable material (e.g., rubber, synthetic rubber, silicone, plastic, etc.) to prevent fluid transfer (e.g., gaseous or liquid) across the perimetric edge of piston head 168. When telescoping piston shaft 307 is fully retracted, piston head 168 may not be in contact with inner walls 204 of container 200. When telescoping piston shaft 307 is at least partially extended, piston head 168 may come into contact with inner walls 204 at the point of flexible seal 170 (e.g., upper flexible ring 175 and/or lower flexible ring 175), along the perimetric edge of piston head 168. Inner walls 204 of container 200 may be substantially vertically oriented but may include a slight inward taper from top to bottom of container 200. In this manner, more of flexible seal 170 may come into contact with inner walls 204 as piston head 168 is lowered further toward bottom surface 208 of container 200.

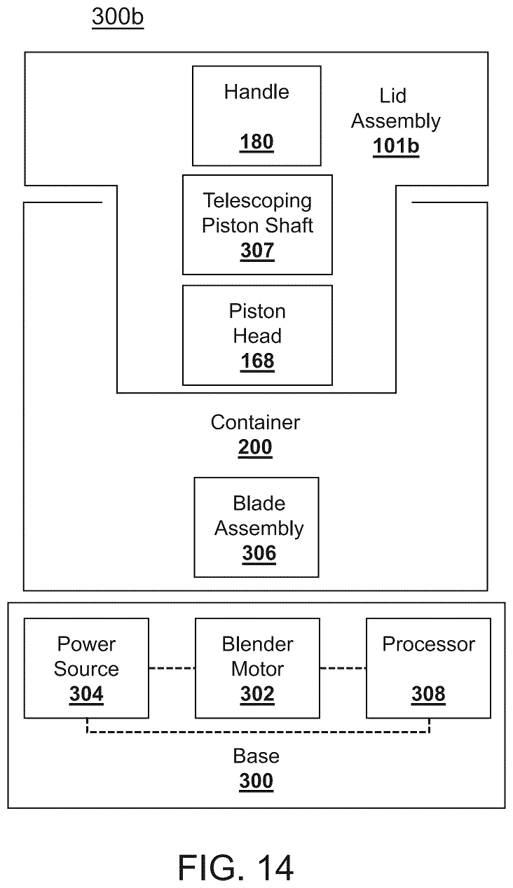

With reference to FIG. 9, FIG. 9 depicts blender system 300b including lid assembly 101b (including telescoping piston shaft 307), container 200 (including blade assembly 306), and base 301. The depicted base 301 is provided for illustrative purposes but is not to be taken as limiting on possible configurations for blender system 300b. Base 301 is shown in profile side view, while lid assembly 101b and container 200 are shown in cross-sectional side view. For more details on the contents and configuration of blender system 300b, including base 301, see FIG. 14 for a corresponding schematic diagram.

In some non-limiting embodiments or aspects, blender system 300b may include base 301. Base 301 may include a power source (e.g., a battery, a power converter with further connection to an external outlet, etc.) (see, e.g., power source 304 of FIG. 14) for powering a blender motor (see, e.g., blender motor 302 of FIG. 14), which may provide the mechanical power for driving blade assembly 306. Base 301 may further include a processor (see, e.g., processor 308 of FIG. 14) configured to control and/or communicate with, at least partly, a user interface of base 301 (e.g., buttons, dials, sliders, touchscreen, switches, etc.). The processor of base 301 may further provide at least partial automatic control to the blender motor and one or more power sources in blender system 300b, including the power source in base 301.

In some non-limiting embodiments or aspects, a user may direct a series of steps to cause blender system 300b to efficiently process contents in container 200. The following illustrative scenario may have a starting configuration with container 200 atop base 301, with lid assembly 101b removed. The user may place contents to be processed (e.g., ice, such as for a snow cone) in container 200. The user may place lid assembly 101b atop container 200, assuring that lid cover 102 (e.g., lid skirt 102 and/or bottom surface 109) is securely in contact with container attachment surface 202. The user may rotate handle 180 in a first rotation direction, which may cause telescoping piston shaft 307 to at least partly telescopically extend toward bottom surface 208 of container 200. In this manner, piston head 168 may create restricted processing volume 215, to promote more efficient processing of the contents. The user may control the extent of the telescoping action by the degree of rotation of handle 180 until a desired depth is achieved, until a sufficient airtight seal is formed around piston head 168, and/or until piston head 168 cannot further compact contents in container 200.

The user may activate a processing function of blender system 300b, such as by interacting with the user interface of base 301. For example, the user may select a “Crush” functional setting button, which may cause a blender motor of base 301 to activate in pulses, and which may cause blade assembly 306 to rapidly spin in intervals. As blade assembly 306 rapidly spins, the contents being processed may be prevented from scattering or cavitating due to restricted processing volume 215. When sufficient processing has occurred, the blender motor of base 301 may be deactivated, either automatically by an onboard processor or in response to user control. The user may then rotate handle 180 in a second rotation direction, which may cause telescoping piston shaft 307 to at least partly telescopically retract from bottom surface 208 of container 200. The user may control the retraction of the telescoping action by the degree of rotation of handle 180 until a desired retraction is achieved, the airtight seal between piston head 168 and inner walls 204 is broken, and/or until piston head 168 cannot be retracted up any further. The user may then remove lid assembly 101b from container 200 or open an access panel in lid assembly 101b to retrieve the processed contents from container 200.

With reference to FIGS. 10 and 11, FIGS. 10 and 11 depict lid assembly 101b with telescoping piston shaft 307 in a fully extended state. To achieve telescopic extension, a user may rotate handle 180 in a first rotation direction, which may cause, via mechanical connection, first piston shaft segment 150 to rotate in the first rotation, which may cause piston shroud 132 to translate downward, which may cause second piston shaft segment 155 to translate downward. Furthermore, the rotation of first piston shaft segment 150 in the first rotation direction may cause second piston shaft segment 155 to rotate in the first rotation direction as well, which may cause third piston shaft segment 160 to translate downward. This transference of rotation and movement may result in second piston shaft segment 155 slidably extending downward away from the position of first piston shaft segment 150, and may result in third piston shaft segment 160 slidably extending downward away from the position of both first piston shaft segment 150 and second piston shaft segment 155. The movement of third piston shaft segment 160 may cause piston head 168 to translate downward as well.

In some non-limiting embodiments or aspects, to achieve telescopic retraction, the user may rotate handle 180 in a second rotation direction opposite the first rotation direction, which may cause, via mechanical connection, first piston shaft segment 150 to rotate in the second rotation direction, which may cause piston shroud 132 to translate upward, which may cause second piston shaft segment 155 to translate upward. Furthermore, the rotation of first piston shaft segment 150 in the second rotation direction may cause second piston shaft segment 155 to rotate in the second rotation direction as well, which may cause third piston shaft segment 160 to translate upward. This transference of rotation and movement may result in second piston shaft segment 155 slidably retracting upward into the first piston shaft segment 150, and may result in third piston shaft segment 160 slidably retracting upward into the second piston shaft segment 155. The movement of the third piston shaft segment 160 may also cause piston head 168 to translate upward as well.

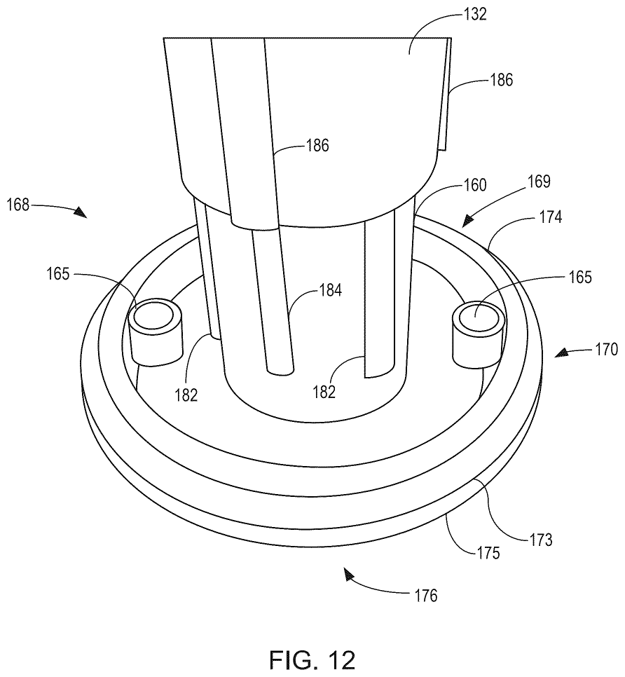

Referring now to FIG. 12, FIG. 12 is a view of a lower portion of telescoping piston shaft 307 and piston head 168, according to non-limiting embodiments or aspects of the present disclosure. In particular, FIG. 12 is a perspective view of a lower portion of telescoping piston shaft 307 (e.g., piston shroud 132, third piston shaft 160) and piston head 168 of a lid assembly (see, e.g., lid assembly 101a of FIGS. 1-5, lid assembly 101b of FIGS. 7-11).

In some non-limiting embodiments or aspects, piston head 168 may be connected to third piston shaft segment 160. Piston shroud 132 may at least partly cover third piston shaft segment 160, such that third piston shaft segment 160 may recede at least partly into piston shroud 132 when telescoping piston shaft 307 retracts. To improve the linear translation component of the telescoping action, telescoping piston shaft 307 may include a series of guide channels and expansion guides. For example, piston shroud 132 may include one or more expansion guides 186 (e.g., protrusions, detents, ridges, etc.) along a direction of expansion of telescoping piston shaft 307. Expansion guides 186 may fit into a corresponding guide channel (not shown) of piston cavity 140 of lid assembly 101a, 101b, so that piston shroud 132 smoothly and linearly translates in and out of piston cavity 140. Guide channels to receive expansion guides 186 may include receiving channel 144 (see, e.g., FIG. 4).

In some non-limiting embodiments or aspects, third piston shaft segment 160 may include one or more expansion guides 182 along a direction of expansion of telescoping piston shaft 307. Expansion guides 182 may fit into a corresponding guide channel (not shown) on the interior wall of piston shroud 132, so that third piston shaft segment 160 smoothly and linearly translates in and out of piston shroud 132. Guide channels to receive expansion guides 182 may include receiving channel 139 (see, e.g., FIG. 4). Third piston shaft segment 160 may further include one or more guide channels 184 to receive one or more expansion guides (not shown) on an interior of piston shroud 132. Expansion guides to fit into guide channels 184 may include lower detent 136 of piston shroud 132 (see, e.g., FIG. 4).

In some non-limiting embodiments or aspects, piston head 168 may act as a substantially planar separation between a lower portion of container 200 and an upper portion of container 200. Contents to be processed may be confined below lower surface 176 of piston head 168. One or more valves 165 in piston head 168 may be configured to selectively permit gaseous fluid transfer from lower surface 176 of piston head 168 through upper surface 169 of piston head 168. For example, when telescoping piston shaft 307 is extending and/or retracting, valves 165 may be opened to permit air to transfer from below piston head 168 to above piston head 168. By way of further example, when processing of contents is occurring, valves 165 may be closed to prevent fluid transfer from below piston head 168 to above piston head 168. It will be appreciated that valves 165 may include one-way valves, which only permit gaseous fluid transfer from beneath piston head 168 as it is lowered into container 200.

In some non-limiting embodiments or aspects, piston head 168 may seal off restricted processing volume 215 by way of flexible seal 170 on a perimetric edge of piston head 168. Flexible seal 170 may include lower section 172 adjacent lower surface 176 and may extend to upper section 174 adjacent upper surface 169. Furthermore, flexible seal 170 may include one or more flexible rings (e.g., gaskets, elastic rings, piston seals, etc.) to prevent fluid transfer across the perimetric edge of piston head 168. For example, flexible seal 170 may include upper flexible ring 173 and lower flexible ring 175 to provide multiple barriers to prevent fluid transfer around the lip of piston head 168. It will be appreciated that only one flexible ring may be employed, or more than two flexible rings may be employed, for added engineering redundancies.

Referring now to FIG. 13, FIG. 13 is a diagram of a blender system 300a, according to non-limiting embodiments or aspects of the present disclosure. In particular, FIG. 13 is a schematic diagram of blender system 300a that includes motor 110 to provide motor-driven power for extending and retracting telescoping piston shaft 307. Cross-sectional and perspective views of blender system 300a are shown in further detail in FIG. 3. The depicted blender system 300a may have additional or fewer components than those shown and is provided only for illustrative purposes.

In some non-limiting embodiments or aspects, blender system 300a may include three primary assemblies: lid assembly 101a, container 200, and base 301. Lid assembly 101a may be configured to close an open end of container 200 and may provide the ability to restrict an active processing volume in container 200, nearest the processing blades. Container 200 may be configured to contain contents being processed, both during operation of active processing, and post-processing, such as in a refrigerator for storage. Base 301 may be configured to provide power and control to blender system 300a, such as to drive and control blade assembly 306, drive and control telescoping piston shaft 307, and/or the like.

In some non-limiting embodiments or aspects, lid assembly 101a may include, but is not limited to, power source 303, motor 110, telescoping piston shaft 307, and piston head 168. Power source 303 may be configured to provide electrical power to motor 110, to cause motor 110 to provide mechanical power for the movement of telescoping piston shaft 307. Power source 303 may include a capacitor, such as a battery, and may be formed in or on motor 110. Additionally or alternatively, power source 303 may include an electrical connection to power source 304 in base 301. For example, an electrical path (e.g., wiring) may extend from power source 304 in base 301, through container 200 (e.g., inside or on a handle, wall, or combination thereof), to power source 303 in lid assembly 101a. When motor 110 receives electricity from power source 303, either independently or in conjunction with power source 304, motor 110 may extend and/or retract telescoping piston shaft 307, causing piston head 168 to move within container 200.

In some non-limiting embodiments or aspects, container 200 may include, but is not limited to, blade assembly 306. Container 200 may be configured to receive lid assembly 101a on an open, upper end of container 200. Container 200 may be further configured to sit upon and engage base 301. A bottom of container 200 may include a shaft or slot to receive a shaft, to receive mechanical power from blender motor 302 of base 301. Furthermore, the walls of container 200 may be configured with a shape and dimension that corresponds to the shape and dimension of piston head 168, such that piston head 168 may create a seal around the entire perimeter of piston head 168 inside container 200 when telescoping piston shaft 307 is at least partially extended.

In some non-limiting embodiments or aspects, base 301 may include, but is not limited to, power source 304, blender motor 302, and processor 308. Base 301 may further include a user interface for receiving user input. Power source 304 may include a capacitor, such as a battery, to provide electrical power to blender motor 302, power source 303, and/or motor 110. Additionally or alternatively, power source 304 may include an electrical connection to an external power source, such as a corded connection to an electrical outlet. Processor 300 may include, but is not limited to, an electronic control unit (ECU), which may include microcontrollers (e.g., to control motor speed, monitor sensors, and control the user interface), motor controllers (e.g., dedicated circuits to manage the operation of blender motor 302 and/or motor 110, such as starting, stopping, and regulating speed), and/or sensors (e.g., to detect load, resistance, speed, temperature, balance, and/or the like). Additionally, or alternatively, processor 300 may include a wired or wireless transceiver to communicate with an external computing device (e.g., a mobile device).

Referring now to FIG. 14, FIG. 14 is a diagram of blender system 300b, according to non-limiting embodiments or aspects of the present disclosure. In particular, FIG. 14 is a schematic diagram of blender system 300b that includes handle 180 to provide manual-driven power for extending and retracting telescoping piston shaft 307. Cross-sectional and perspective views of blender system 300b are shown in further detail in FIG. 9. The depicted blender system 300b may have additional or fewer components than those shown and is provided only for illustrative purposes.

In some non-limiting embodiments or aspects, blender system 300b may include three primary assemblies: lid assembly 101b, container 200, and base 301. Lid assembly 101b may be configured to close an open end of container 200 and may provide the ability to restrict an active processing volume in container 200, nearest the processing blades. Container 200 may be configured to contain contents being processed, both during operation of active processing, and post-processing, such as in a refrigerator for storage. Base 301 may be configured to provide power and control to blender system 300b, such as to drive and control blade assembly 306.

In some non-limiting embodiments or aspects, lid assembly 101b may include, but is not limited to, handle 180, telescoping piston shaft 307, and piston head 168. A user may manually rotate handle 180 in one direction or another to cause telescoping piston shaft 307 to extend or retract, which may cause piston head 168 to move within container 200. It will be appreciated that the depicted lid assembly 101b may additionally or alternatively include a motor for controlling telescoping piston shaft 307, such as shown in FIG. 13.

In some non-limiting embodiments or aspects, container 200 may include, but is not limited to, blade assembly 306. Container 200 may be configured to receive lid assembly 101b on an open, upper end of container 200. Container 200 may be further configured to sit upon and engage base 301. A bottom of container 200 may include a shaft or slot to receive a shaft, to receive mechanical power from blender motor 302 of base 301. Furthermore, the walls of container 200 may be configured with a shape and dimension that corresponds to the shape and dimension of piston head 168, such that piston head 168 may create a seal around the entire perimeter of piston head 168 inside container 200 when telescoping piston shaft 307 is at least partially extended.

In some non-limiting embodiments or aspects, base 301 may include, but is not limited to, power source 304, blender motor 302, and processor 308. Base 301 may further include a user interface for receiving user input. Power source 304 may include a capacitor, such as a battery, to provide electrical power to blender motor 302. Additionally, or alternatively, power source 304 may include an electrical connection to an external power source, such as a corded connection to an electrical outlet. Processor 300 may include, but is not limited to, an ECU. Additionally, or alternatively, processor 300 may include a wired or wireless transceiver to communicate with an external computing device.

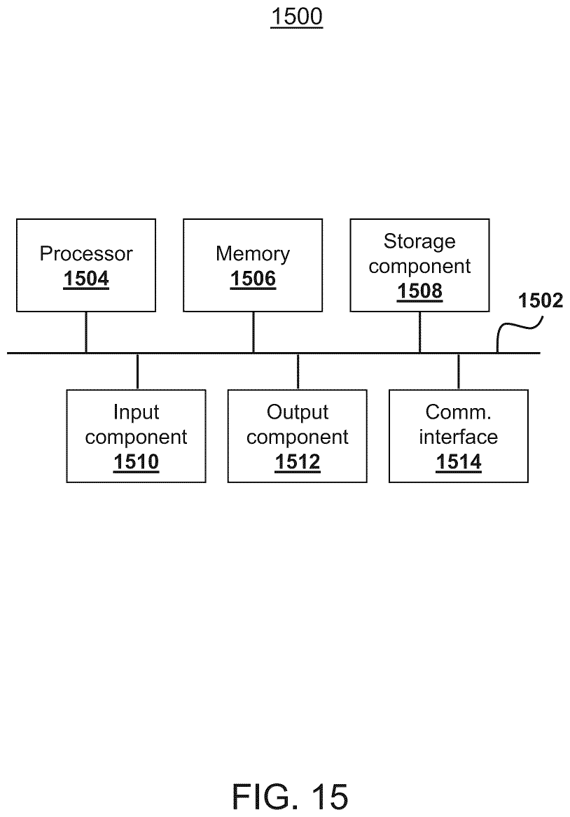

Referring now to FIG. 15, FIG. 15 is a diagram of example components of blender system 300, according to some non-limiting embodiments or aspects. Device 1500 may correspond to blender system 300a, blender system 300b, and/or processor 308 as shown in FIGS. 3, 9, 13, and 14. In some non-limiting embodiments or aspects, such systems or devices may include at least one device 1500 and/or at least one component of device 1500. The number and arrangement of components shown are provided as an example. In some non-limiting embodiments, device 1500 may include additional components, fewer components, different components, or differently arranged components than those shown. Additionally, or alternatively, a set of components (e.g., one or more components) of device 1500 may perform one or more functions described as being performed by another set of components of device 1500.

As shown in FIG. 15, device 1500 may include a bus 1502, a processor 1504, memory 1506, a storage component 1508, an input component 1510, an output component 1512, and a communication interface 1514. Bus 1502 may include a component that permits communication among the components of device 1500. In some non-limiting embodiments, processor 1504 may be implemented in hardware, firmware, or a combination of hardware and software. For example, processor 1504 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 1506 may include random access memory (RAM), read only memory (ROM), and/or another type of dynamic or static storage device (e.g., flash memory, magnetic memory, optical memory, etc.) that stores information and/or instructions for use by processor 1504.

With continued reference to FIG. 15, storage component 1508 may store information and/or software related to the operation and use of device 1500. For example, storage component 1508 may include a hard disk (e.g., a magnetic disk, an optical disk, a magneto-optic disk, a solid-state disk, etc.) and/or another type of computer-readable medium. Input component 1510 may include a component that permits device 1500 to receive information, such as via user input (e.g., a touch screen display, a keyboard, a keypad, a mouse, a button, a switch, a microphone, etc.). Additionally, or alternatively, input component 1510 may include a sensor for sensing information (e.g., a global positioning system (GPS) component, an accelerometer, a gyroscope, an actuator, etc.). Output component 1512 may include a component that provides output information from device 1500 (e.g., a display, a speaker, one or more light-emitting diodes (LEDs), etc.). Communication interface 1514 may include a transceiver-like component (e.g., a transceiver, a separate receiver and transmitter, etc.) that enables device 1500 to communicate with other devices, such as via a wired connection, a wireless connection, or a combination of wired and wireless connections. Communication interface 1514 may permit device 1500 to receive information from another device and/or provide information to another device. For example, communication interface 1514 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 1500 may perform one or more processes described herein. Device 1500 may perform these processes based on processor 1504 executing software instructions stored by a computer-readable medium, such as memory 1506 and/or storage component 1508. A computer-readable medium may include any non-transitory memory device. A memory device includes memory space located inside of a single physical storage device or memory space spread across multiple physical storage devices. Software instructions may be read into memory 1506 and/or storage component 1508 from another computer-readable medium or from another device via communication interface 1514. When executed, software instructions stored in memory 1506 and/or storage component 1508 may cause processor 1504 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

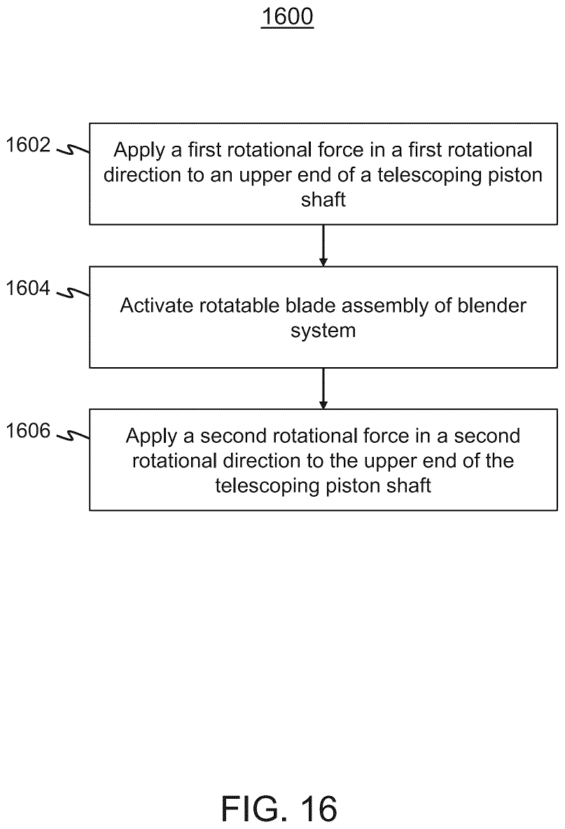

Referring now to FIG. 16, FIG. 16 is a flowchart of a non-limiting embodiment or aspect of a process 1600 for operating a blender system (e.g., blender system 300a, 300b) including a lid assembly (e.g., lid assembly 101a, 101b), according to some non-limiting embodiments or aspects. The steps shown in FIG. 16 are for example purposes only. It will be appreciated that additional, fewer, different, and/or a different order of steps may be used in some non-limiting embodiments or aspects. In some non-limiting embodiments or aspects, one or more of the steps of process 1600 may be performed (e.g., completely, partially, and/or the like) by blender system 300a, 300b and/or processor 308. In some non-limiting embodiments or aspects, one or more of the steps of process 1600 may be performed (e.g., completely, partially, and/or the like) by another system, another device, another group of systems, or another group of devices, separate from or including blender system 300a, 300b, and/or processor 308.

As shown in FIG. 16, at step 1602, process 1600 may include applying a first rotational force in a first rotational direction to an upper end of a telescoping piston shaft connected to a lid cover of the lid assembly, the first rotational force configured to cause the telescoping piston shaft to telescopically extend toward a bottom of a container of the blender system, as show in process step 1602. The process 1600 may further include the step of activating a rotatable blade assembly of the blender system to process contents within a volume of the container, the volume bounded by a lower surface of a piston head comprising a flexible seal along a perimetric edge thereof and connected to a lower end of the telescoping piston shaft, at least one wall of the container engaged with the piston head, and the bottom of the container, as shown in process step 1604. The process 1600 may further include the process step of applying a second rotational force in a second rotational direction opposite the first rotational direction to the upper end of the telescoping piston shaft, the second rotational force configured to cause the telescoping piston shaft to telescopically retract away from the bottom of the container, as shown in process step 1606. The process of applying the first rotational force may include activating a motor of the lid assembly to cause the motor to rotate a drive shaft in a first driving direction that causes a gear assembly connected to the drive shaft to apply the first rotational force in the first rotational direction to the upper end of the telescoping piston shaft. The process of applying the second rotational force may include activating the motor of the lid assembly to cause the motor to rotate the drive shaft in a second driving direction opposite the first driving direction that causes the gear assembly connected to the drive shaft to apply the second rotational force in the second rotational direction to the upper end of the telescoping piston shaft.

While the principles of the disclosed subject matter have been described herein, it is to be understood by those skilled in the art that this description is made only by way of example and not as a limitation as to the scope of the disclosed subject matter. Other embodiments are contemplated within the scope of the presently disclosed subject matter in addition to the exemplary embodiments shown and described herein. Modifications and substitutions by one of ordinary skill in the art are considered to be within the scope of the presently disclosed subject matter, which is not to be limited except by the following claims.

What is claimed is:

1. A lid assembly for use in a blender system, the lid assembly comprising:
a lid cover configured to engage an open end of a container of the blender system;
a telescoping piston shaft connected to the lid cover and configured to telescopically extend toward a bottom of the container and telescopically retract away from the bottom of the container; and
a piston head connected to a lower end of the telescoping piston shaft, the piston head comprising a flexible seal along a perimetric edge of the piston head and configured to engage with at least one wall of the container when the telescoping piston shaft is at least partially extended, the piston head configured to restrict a processing volume of the container to a volume bounded by a lower surface of the piston head, the at least one wall of the container, and the bottom of the container.

2. The lid assembly of claim 1, wherein the telescoping piston shaft comprises at least two piston shaft segments, and wherein a first piston shaft segment of the at least two piston shaft segments is at least partially positioned inside a second piston shaft segment of the at least two piston shaft segments.

3. The lid assembly of claim 2, wherein the at least two piston shaft segments further comprise a third piston shaft segment, and wherein the second piston shaft segment is at least partially positioned inside the third piston shaft segment.

4. The lid assembly of claim 3, wherein the first piston shaft segment and the second piston shaft segment each comprise external threading, wherein the third piston shaft segment comprises internal threading configured to engage with the external threading of the second piston shaft segment, wherein the telescoping piston shaft is configured to telescopically extend when a first rotational force is applied in a first rotational direction to the first piston shaft segment, and wherein the telescoping piston shaft is configured to telescopically retract when a second rotational force is applied in a second rotational direction opposite the first rotational direction to the first piston shaft segment.

5. The lid assembly of claim 4, further comprising a shroud at least partially encasing the second piston shaft segment and configured to slidably engage along an outer surface of the third piston shaft segment, the shroud comprising internal threading configured to engage with the external threading of the first piston shaft segment.

6. The lid assembly of claim 1, further comprising:
a cavity in the lid cover configured to at least partially house the telescoping piston shaft; and
a shroud at least partially encasing the telescoping piston shaft and configured to slidably engage along an outer surface of the telescoping piston shaft, the shroud having a diameter configured to block contents in the container from entering the cavity during operation of the blender system.

7. The lid assembly of claim 1, further comprising:
a gear assembly connected to the lid cover and mechanically engaged with an upper end of the telescoping piston shaft; and
a motor comprising a drive shaft connected to the gear assembly, the motor configured to cause, via the gear assembly, the telescoping piston shaft to telescopically extend when the drive shaft is rotated in a first driving direction, and the motor configured to cause, via the gear assembly, the telescoping piston shaft to telescopically retract when the drive shaft is rotated in a second driving direction opposite the first driving direction.

8. The lid assembly of claim 1, further comprising a rotatable handle connected to the lid cover and mechanically engaged with an upper end of the telescoping piston shaft, the rotatable handle configured to cause the telescoping piston shaft to telescopically extend when the rotatable handle is rotated in a first rotational direction, and the rotatable handle configured to cause the telescoping piston shaft to telescopically retract when the rotatable handle is rotated in a second rotational direction opposite the first rotational direction.

9. The lid assembly of claim 1, wherein the flexible seal of the piston head is configured to restrict fluid transfer across the perimetric edge of the piston head when the flexible seal is engaged with the at least one wall of the container, and wherein the piston head further comprises at least one valve configured to permit gaseous fluid transfer from a lower surface of the piston head through an upper surface of the piston head when the telescoping piston shaft is telescopically extended while the flexible seal of the piston head is engaged with the at least one wall of the container.

10. A blender system comprising:
a base;
a container configured to be removably attached to the base, the container further configured to contain contents to be processed during operation of the blender system;
a rotatable blade assembly positioned at least partly in the container; and
a lid assembly comprising:
a lid cover configured to engage an open end of the container;
a telescoping piston shaft connected to the lid cover and configured to telescopically extend toward a bottom of the container and telescopically retract away from the bottom of the container; and
a piston head connected to a lower end of the telescoping piston shaft, the piston head comprising a flexible seal along a perimetric edge of the piston head and configured to engage with at least one wall of the container when the telescoping piston shaft is at least partially extended, the piston head configured to restrict a processing volume of the container to a volume bounded by a lower surface of the piston head, the at least one wall of the container, and the bottom of the container.

11. The blender system of claim 10, wherein the telescoping piston shaft comprises at least two piston shaft segments, and wherein a first piston shaft segment of the at least two piston shaft segments is at least partially positioned inside a second piston shaft segment of the at least two piston shaft segments.

12. The blender system of claim 11, wherein the at least two piston shaft segments further comprise a third piston shaft segment, and wherein the second piston shaft segment is at least partially positioned inside the third piston shaft segment.

13. The blender system of claim 12, wherein the first piston shaft segment and the second piston shaft segment each comprise external threading, wherein the third piston shaft segment comprises internal threading configured to engage with the external threading of the second piston shaft segment, wherein the telescoping piston shaft is configured to telescopically extend when a first rotational force is applied in a first rotational direction to the first piston shaft segment, and wherein the telescoping piston shaft is configured to telescopically retract when a second rotational force is applied in a second rotational direction opposite the first rotational direction to the first piston shaft segment.

14. The blender system of claim 13, wherein the lid assembly further comprises a shroud at least partially encasing the second piston shaft segment and configured to slidably engage along an outer surface of the third piston shaft segment, the shroud comprising internal threading configured to engage with the external threading of the first piston shaft segment.

15. The blender system of claim 10, wherein the lid assembly further comprises:
a cavity in the lid cover configured to at least partially house the telescoping piston shaft; and
a shroud at least partially encasing the telescoping piston shaft and configured to slidably engage along an outer surface of the telescoping piston shaft, the shroud having a diameter configured to block contents in the container from entering the cavity during operation of the blender system.

16. The blender system of claim 10, wherein the lid assembly further comprises:
a gear assembly connected to the lid cover and mechanically engaged with an upper end of the telescoping piston shaft; and
a motor comprising a drive shaft connected to the gear assembly, the motor configured to cause, via the gear assembly, the telescoping piston shaft to telescopically extend when the drive shaft is rotated in a first driving direction, and the motor configured to cause, via the gear assembly, the telescoping piston shaft to telescopically retract when the drive shaft is rotated in a second driving direction opposite the first driving direction.

17. The blender system of claim 10, wherein the lid assembly further comprises a rotatable handle connected to the lid cover and mechanically engaged with an upper end of the telescoping piston shaft, the rotatable handle configured to cause the telescoping piston shaft to telescopically extend when the rotatable handle is rotated in a first rotational direction, and the rotatable handle configured to cause the telescoping piston shaft to telescopically retract when the rotatable handle is rotated in a second rotational direction opposite the first rotational direction.

18. The blender system of claim 10, wherein the flexible seal of the piston head is configured to restrict fluid transfer across the perimetric edge of the piston head when the flexible seal is engaged with the at least one wall of the container, and wherein the piston head further comprises at least one valve configured to permit gaseous fluid transfer from a lower surface of the piston head through an upper surface of the piston head when the telescoping piston shaft is telescopically extended while the flexible seal of the piston head is engaged with the at least one wall of the container.

19. A method of operating a blender system comprising a lid assembly, the method comprising:
applying a first rotational force in a first rotational direction to an upper end of a telescoping piston shaft connected to a lid cover of the lid assembly, the first rotational force configured to cause the telescoping piston shaft to telescopically extend toward a bottom of a container of the blender system;
activating a rotatable blade assembly of the blender system to process contents within a volume of the container, the volume bounded by a lower surface of a piston head comprising a flexible seal along a perimetric edge thereof and connected to a lower end of the telescoping piston shaft, at least one wall of the container engaged with the piston head, and the bottom of the container; and
applying a second rotational force in a second rotational direction opposite the first rotational direction to the upper end of the telescoping piston shaft, the second rotational force configured to cause the telescoping piston shaft to telescopically retract away from the bottom of the container.

20. The method of claim 19, wherein applying the first rotational force comprises:
activating a motor of the lid assembly to cause the motor to rotate a drive shaft in a first driving direction that causes a gear assembly connected to the drive shaft to apply the first rotational force in the first rotational direction to the upper end of the telescoping piston shaft; and
wherein applying the second rotational force comprises:
activating the motor of the lid assembly to cause the motor to rotate the drive shaft in a second driving direction opposite the first driving direction that causes the gear assembly connected to the drive shaft to apply the second rotational force in the second rotational direction to the upper end of the telescoping piston shaft.
